(19) United States
(12) Patent Application Publication
(10) Pub. No.: US 2018/0150508 A1
(43) Pub. Date: May 31, 2018

(54) Structured Inquiry language

(71) Applicant: Mansur Nizamul Gouse Baban, Irving, TX (US)

(72) Inventor: Mansur Nizamul Gouse Baban, Irving, TX (US)

(21) Appl. No.: 15/361,374

(22) Filed: Nov. 26, 2016

(51) Int. Cl. G06F 17/30; G06F 17/28

(52) U.S. Cl. CPC G06F 17/30401; G06F 17/3056; G06F 17/3041; G06F 17/2836

(57) ABSTRACT

The present invention is a system application software for creation and execution of Structured Query Language (SQL) statements in different languages. Currently, all SQL statements are only in the English language. Through this invention (SIL), SQL statements have been made multilingual. SIL stands for Structured Inquiry Language. Each SQL syntax, key word, statement, function, procedure and error message in English has an equivalently translated SIL syntax in different languages. Examples of the created SIL are SIL—Arabic, SIL—Hindi, SIL—Spanish, SIL—Germany, SIL—Russian, SIL—Chinese, SIL—French, etc. The examples used in this documents are for SIL—Hindi, SIL—Arabic, and SIL—Spanish.

### SUMMARY OF THE INVENTION

The SIL is a software client application for users to access and manipulate data in DBMS/RDBMS or any other system which accepts SQL queries This includes MySQL, SQL Server, Oracle, Sybase, DB2, and other database systems. The users will be able to create SQL queries in their own languages and perform Data Definition and Data Manipulation by creating, editing and managing data.

SIL can do the following:

1. SIL can execute queries against a database.

2. SIL can retrieve data from a database.

3. SIL can insert, update and delete records in a database.

4. SIL can create new databases.

5. SIL can create new tables in a database.

6. SIL can create functions, store procedures, and views in a database.

In brief, SIL can do all the operations on a database which are done using SQL but, in user native language.

### BACKGROUND OF THE INVENTION

Structural Query Language (SQL) statements, keywords, functions, procedures, error messages and syntax are ONLY in the English language. People who do not know the English language cannot execute and understand SQL statements. This problem has led to the birth of the Structural Inquiry Language (SIL). SIL addresses the issue of creating SQL statements in other languages of the world. SIL takes the statements, keywords, functions, procedures, and syntaxes in other languages and converts them into SQL queries. In the background, the processing is done against SQL query. The invention relates to Data processing using Extraction, Transformation and Loading (ETL) of Data against DBMS/RDBMS systems or any system which accepts SQL queries.

### DESCRIPTION OF THE INVENTION

Systems Inquiry Language (SIL) is a multilingual SQL. It is used to communicate with relational database management systems (RDBMS)/database management systems (DBMS). The diagram describes start to end working of SIL. Non-English speaking people can use SIL to create SQL statements in their own language.

### DESCRIPTION OF THE DIAGRAM

At 100, it shows the complete detailed flow and execution of SIL.

At 101, SIL Editor is a window where the user is able to create queries and communicate with database using SIL statements in any language. The user can select any of the available SIL languages (for example, Hindi, Arabic, etc.) and communicate with the database in that chosen language. All the statements, queries, and functions which are created using SQL can be created in other languages using SIL. The user is provided with a SIL user guide which contains a list of words in his native language. These words correspond to SQL words. The user creates SIL statements and submits them for execution.

At 102, SIL queries are executed by clicking the RUN button on SIL Editor window.

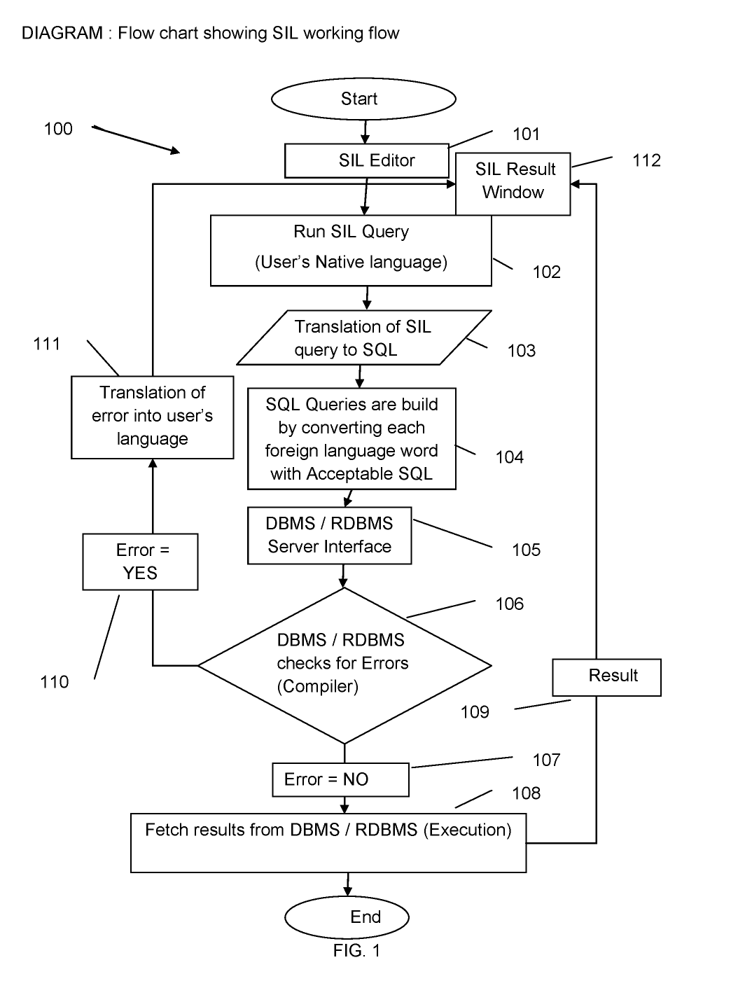

At 103, SIL translator is a background process for converting the SIL queries into the SQL language that is understood by the databases. The translation is done using computer language C++ coding. In the background, SIL queries are converted into SQL queries before getting executed. In FIG. 1 at 104, the translation into English is done by word to word mapping using conditional logic in which the SIL query is broken word by word. Then, those words are translated one by one using conditional logic and joined together to make a SQL query.

### EXAMPLE 1

### SIL Hindi Query is Written as Follows

[symbol] * [symbol] ; the words are broken as [symbol] , *, [symbol] . It is translated as select, *, from, table_name, and joined as select * from employee. In this example, “employee” is the table name.

### EXAMPLE 2

### SIL Arabic Query is Written as Follows

[symbol] * [symbol] ; the words are broken as [symbol] , *, [symbol] . It is translated as select, *, from, table_name, and joined as select * from employee. In this example, “employee” is the table name.

### EXAMPLE 3

### SIL Spanish Query is Written as Follows

seleccionar * de mesa_nombre; the words are broken as seleccionar, *, de, mesa_nombre. It is translated as select, *, from, table_name, and joined as select * from employee. In this example, “employee” is the table name.

At 105, the interface provides a link between the database and SIL to interact with each other. This interface is the connection string which is written in the background code of the SIL. Every DBMS/RDBMS has its own connection string. For example the connection string for DBMS—PostgreSQL is as shown below:

“server=localhost, port=5432, database=db_name, username=postgres, password=password”

By using this connection string, we are able to enter into the PostgreSQL database. The user must provide these details in the login page which contains the above fields. SIL accepts data provided by user and passes to the background code to make a successful connection. The field ‘database’ in the connection string is optional for making a connection. It is required while executing queries. The connection to the database will be open until the user quits the application.

In a similar way, we can connect to other databases like MySQL, SQL Server, Oracle, etc. The interaction of SIL will be the same with all the other databases to which it can be connected (as is done with PostgreSQL). The complete query execution will be done in the database and the result will be fetched from it and passed to the SIL window.

At 106, 107, and 108, once the SIL query is translated into SQL query through the mechanism described (at 103), the SQL is passed to DBMS/RDBMS. The DBMS/RDBMS compiler checks for errors. The compiler produces either error or no-error. If there is no-error, then the database executes SQL statements and produces the result.

At 109, the result from the database is displayed in the SIL result window at 112.

At 110 and 111, based on 106, if there is an error produced by the database, then the error message is translated. The translation into user native language from English is done by word to word mapping using conditional logic in which the SQL error message is broken word by word. Then, those words are translated one by one using conditional logic and joined together to make a SIL error message in the user native language. This message is displayed in the result window at 112.

1. SIL is a process for the creation and execution of Structured Query Language (SQL) statements in different languages. During this process, a document is provided to the user with a list of his native language words. Each word stands for an equal word of the SQL statement including syntax, keywords, functions, procedures, formulas, rules, keys, and symbols which are present in English.
The SIL software client application allows and accepts user native Language SQL statements. The user creates SIL statement in his native language in the editor window of the SIL application.

2. A process analyses the submitted SIL statement and breaks it into native language words and symbols.

3. The native language SIL words and symbols are matched and translated using conditional computer programming to an acceptable format and syntax of the SQL.

4. A connection to the data base management system (DBMS)/relational data base management system (RDBMS) or to a system which accepts SQL statements is made using a computer programme.

5. The DBMS or RDBMS or the source data system executes acceptable SQL statements and returns the result. The result is data or error message.

6. A process analyses the error message and converts it into SQL words and symbols.

7. The SQL words and symbols are translated into the user's native language using conditional computer programming and a message is built.

8. The error message is displayed to the user in native language on SIL software client application.

9. The result as Data is displayed to the user on SIL software client application.
